(19) United States
(12) Patent Application Publication
(10) Pub. No.: US 2016/0060463 A1
(43) Pub. Date: Mar. 3, 2016

(54) Pastes Containing Solvent

(71) Applicant: CLARIANT INTERNATIONAL LTD, Muttenz (CH)

(72) Inventors: Rosemarie WEBER, Edenbergen (DE); Gerd HOHNER, Augsburg (DE); Timo HERRLICH, Buehl (DE); Stefanie GOERES, Worms (DE); Anton LUKASCH, Meitingen (DE); Rainer FELL, Gersthofen (DE)

(73) Assignee: CLARIANT INTERNATIONAL LTD., Muttenz (CH)

(21) Appl. No.: 14/783,812

(22) PCT Filed: Apr. 4, 2014
(86) PCT No.: PCT/EP2014/000907

§ 371 Date: Oct. 9, 2015

(30) Foreign Application Priority Data
Apr. 12, 2013 (DE) 10 2013 006 347.7

(51) Int. Cl. C08L 91/06; C09G 1/08

(52) U.S. Cl. CPC C08L 91/06; C09G 1/08

(57) ABSTRACT

The invention relates to paste preparations containing 0.5-30% w/w chemically unmodified rice bran wax, —0.5-30% w/w paraffin wax, selected from the group of macrocrystalline and microcrystalline paraffins and Fischer-Tropsch paraffins, —optionally up to a maximum of 10% w/w polyethylene wax, —optionally up to a maximum of 10% w/w native or chemically modified recent or fossil vegetable waxes and—organic solvents to make up to 100% w/w.

The invention relates to paste-like solvent-containing wax preparations having an improved shine-imparting effect and improved retention values. It further relates to a process for producing such preparations and their use for the care of shoes, floor coverings, automobile bodies and leather.

Waxes are widely used as formulation components for producing solvent-containing pastes for use in, for example, floor care, automobile care and shoe care (cf. Ullmann's Encyclopedia of Industrial Chemistry, 5^{th} edition, vol. A 28, pages 108, 153, 156, Weinheim 1996). Wax pastes are formed by allowing hot wax solutions in organic solvents to cool. The paste form makes a simple application of the waxes possible: after mechanical distribution of the paste on the surface to be treated, the solvent evaporates and a polishable wax film which has a protective, nurturing or other effect remains.

As wax components for formulating suitable pastes, use is made of nonpolar and/or polar waxes of natural, partially synthetic or fully synthetic origin.

Chemically modified montan waxes have for a long time been of considerable importance as paste waxes. The starting material here is crude montan wax which is obtained by solvent extraction from wax-containing brown coal and is made up of, inter alia, esters of long-chain aliphatic carboxylic acids with long-chain aliphatic alcohols. Unmodified (native) crude montan wax is not suitable for direct use in pastes because of its dark color and its content of resin-like accompanying substances. Chemical refining of the crude wax is effected by treatment with chromic-sulfuric acid. Here, the undesirable components are firstly destroyed by oxidation and a substantial, stepwise change in the chemical nature of the wax occurs in parallel, beginning with hydrolysis of the esters in which cleavage to give carboxylic acids and higher alcohols occurs. The latter are subsequently oxidized to form carboxylic acids, so that overall degradation of long-chain ester molecules to shorter-chain carboxylic acid molecules takes place. These are in turn converted in subsequent synthetic steps into wax esters or wax soaps which can be used to formulate pastes of good quality. They are therefore also referred to as partially synthetic waxes.

The Japanese patent application JP 36005526 describes the production of solvent-containing polish compositions in which a chemically modified wax, which can likewise be considered to be a partially synthetic wax, based on rice bran wax (hereinafter: rice wax) is present. According to said document, the modification is a prerequisite for the practical usability of the wax and is effected by oxidation of crude rice wax by means of chromium trioxide or chromic acid salts in the presence of sulfuric acid and optionally subsequent esterification and/or hydrolysis of the acid groups formed. This process is in principle identical with the above-described chemical refining of crude montan wax. According to the teaching of JP 36005526, unmodified rice wax is unsuitable as active substance in paste formulations. The modification process is complicated and requires handling of toxic, environmentally hazardous substances which are problematical to produce or to dispose of.

The category of chemically unmodified (native) waxes of natural origin, in so far as they come into question for pastes, includes firstly particular nonpolar paraffin waxes, known as macrocrystalline or microcrystalline paraffins, which are obtained as nonvolatile fractions in the refining of fossil crude oil and secondly some natural recent vegetable waxes which owing to their contents of oxygen compounds have polar characters. Mention may here be made of, in particular, carnauba wax which is formed as protective layer against drying out on the leaves of the carnauba palm which is mostly native to South America. It is harvested by manual beating or cooking of the leaves and, after various purification steps, is marketed essentially without chemical modification for various uses.

The class of the native vegetable waxes, which are widely used for paste wax formulations, likewise includes candelilla wax which is deposited on the stems and leaves of particular Euphorbia and Pendilanthus species which occur in dry regions in America, and is obtained therefrom by heating and melting-off.

Carnauba wax in particular historically had considerable economic importance as paste constituent but, like candelilla wax, does not meet all requirements in respect of quality.

The synthetic waxes mentioned are generally nonpolar polyolefin waxes, in particular polyethylene waxes, or Fischer-Tropsch paraffins. Fischer-Tropsch waxes are produced catalytically from synthesis gas. They are structurally similar to polyethylene waxes but differ therefrom by having lower average molar masses, narrower molar mass distributions and lower melt viscosities.

An important quality-determining property of usable pastes is the solvent retention. This is a measure of the rate at which the solvent present in the formulation mixture evaporates. The smaller the evaporation loss, i.e. the better the retention value, the more stable is the paste and the lower is the tendency of the paste to dry out during storage. Demanding stability requirements naturally have to be met particularly in hot countries or regions. It is just these places, for instance in Central and South America, where paste compositions still traditionally play an important role for shoe care. To determine the retention value quantitatively, the weight loss of a sample having defined dimensions is measured after storage under defined conditions.

An important practical requirement for paste compositions, in so far as they are used in the care composition sector, is the surface shine which can be achieved after application to the substrate and subsequent polishing (“shine-imparting effect”). Standardized preparation and measurement methods are available for the quantitative determination of this.

To match the wide variety of use requirements to one another in an optimal way, pastes are in principle formulated on an empirical basis from a plurality of different types of wax. In general, both polar and nonpolar waxes of natural origin and also synthetic or partially synthetic waxes are used at the same time.

Rice wax is, according to Ullmann's Encyclopedia of Industrial Chemistry, 5th edition 1996, vol. A28, pages 117-118, one of a group of recent waxes which have hitherto been considered to be of only local importance or merely academic interest. The use of native rice wax in cosmetics (EP B1 1343454; also Bräutigam, Lexikon der kosmetischen Rohstoffe, Norderstedt 2010, page 77), as processing aids in plastics (JP 10007862; JP 60011553; JP 49090739; JP 60011553) and also in printing inks and electrophotographic toners (JP 2010020304) has been described.

Contrary to the abovementioned conceptions which represent the prior art, in particular contrary to the teachings of JP 36005526, it has now surprisingly been found that rice wax is highly suitable for the production of pastes without prior chemical modification and that in respect of important quality criteria is even superior to the types of wax customarily used for this application. Specifically by concomitant use of rice wax in formulations, pastes having superior retention and high shine-imparting effects can be obtained. This opens up new potential uses for a renewable raw material which is available in large quantities as by-products.

The invention therefore provides paste-like preparations which have high shine-imparting effects and low evaporation losses (high retention values) and comprise
0.5-30% by weight of chemically unmodified rice bran wax,
0.5-30% by weight of paraffin wax selected from the groups of macro- and microcrystalline paraffins and Fischer-Tropsch paraffins,
optionally up to 10% by weight of polyethylene wax,
optionally up to 10% by weight of native or chemically modified vegetable waxes and
organic solvents to make up to 100% by weight.

The invention further provides a process for producing such paste-like preparations and their use for floor care and for the care of automobile bodies and of leather.

Rice wax is obtained in the processing of paddy rice (Oryza sativa) as harvested. After threshing of the ripe rice plants, where the outer hulls adhering to the grains have been removed and further hull constituents together with other impurities have been separated out in the rice mill, the rice grains still contain the germ and are surrounded by the silverskin. Germ and silverskin are removed by polishing in a further processing step and give the rice bran in addition to the polished rice. The rice bran contains lipid constituents which consist predominantly of fatty oils and a smaller percentage of wax-like components. The latter are present in the oil obtained from the bran by pressing or solvent extraction, from which oil they are isolated on the basis of their sparing solubility at low temperatures, e.g. by freezing out. Rice wax consists mainly of esters of long-chain saturated unbranched fatty acids with long-chain unbranched aliphatic alcohols. Behenic and lignonceric acids having the chain lengths C₂₂ and C₂₄ predominate in the acid part and the chain lengths C₃₀, C₃₂ and C₃₄ predominate in the alcohol part.

As rice wax for the purposes of the invention, it is possible to use wax-like constituents obtained from rice bran by any separation processes. Preference is given to the wax constituents isolated from rice bran oil in a known manner, e.g. by freezing out or extraction. These wax constituents can be used for producing the pastes either as such or after mechanical or physical purification, e.g. by treatment with bleaching earths and/or with activated carbon and/or after bleaching by means of hydrogen peroxide. It is also possible to subject each of the abovementioned processing stages to an additional fractionation by known methods and to further process a selection of the resulting fractions in the manner according to the invention. Possible fractionation methods are, for example, extractive fractionation using organic solvents such as ethanol, isopropanol, acetone, aliphatic open-chain or alicyclic hydrocarbons such as hexane or cyclohexane or mixtures thereof; the starting wax can, for instance, be separated into soft and hard wax constituents, e.g. those having flow hardnesses above and below 250 bar. The determination of the flow hardnesses is carried out according to the “Einheitsmethoden” M-IV 2 (75) or M-III 13(75) of the Deutschen Gesellschaft für Fettchemie.

Rice waxes which are suitable for the purposes of the invention have acid numbers determined in accordance with DIN 53402, in the range from 3 to 20 mg KOH/g, hydrolysis numbers, determined in accordance with DIN 53401, in the range from 50 to 130 mg KOH/g, dropping points in accordance with DIN 51801-2 in the range from 70 to 87° C., melt viscosities measured in accordance with DIN 51562 at 90° C. using a rotational viscometer in the range from 5 to 30 mPa·s and flow hardnesses in the range from 150 to 400 bar.

According to the invention, the rice wax is not chemically modified. For the present purposes, the term chemical modification refers to measures in which the chemical structure of the native wax is fundamentally changed, e.g. in the sense of substantial hydrolysis or other chemical transformation, as occurs, for instance, in the case of oxidation using chromic-sulfuric acid. In contrast, bleaching with hydrogen peroxide is not chemical modification of the wax for the purposes of the invention since this bleaching merely removes discoloring impurities and secondary constituents without the actual wax structure being altered.

Rice wax is present in the paste-like preparation in proportions by weight of from 0.5 to 30%, preferably from 3 to 20%, particularly preferably from 5 to 15%.

The paraffin waxes which can be used according to the invention are macrocrystalline or microcrystalline paraffins from the processing of fossil crude oil or are Fischer-Tropsch paraffins. Macrocrystalline paraffins are obtained from the vacuum distillate fractions of crude oil. They consist predominantly of n-paraffins. Microcrystalline paraffins originate from the residues from vacuum distillation and the sediments of paraffinic crude oils. They contain n-paraffins and isoparaffins and also considerable proportions of naphthenic hydrocarbon components. Information on the isolation and characteristics of macrocrystalline and microcrystalline paraffin waxes and also examples of these may be found in Ullmann's Encyclopedia of Industrial Chemistry, 5^{th} edition, vol. A 28, Weinheim 1996, in chapters 4.2 and 4.3.

Fischer-Tropsch paraffins are produced catalytically from synthesis gas. They are structurally similar to polyethylene waxes but differ from these by having lower average molar masses, narrower molar mass distributions and lower melt viscosities (cf. Ullmann's Encyclopedia of Industrial Chemistry, 5^{th} edition, vol. A 28, Weinheim 1996, chapter 5.).

Paraffin and/or Fischer-Tropsch waxes are present in the paste-like preparation of the invention in proportions by weight of from 0.5 to 30%, preferably from 3 to 20%, particularly preferably from 5 to 17%.

Polyethylene waxes are formed by ethylene polymerization, which can be carried out either under free-radical conditions at high pressures and temperatures or with the aid of metal-containing catalysts under comparatively milder pressure and temperature conditions. In the latter case, ethylene is either polymerized in pure form to give largely unbranched highly crystalline chain structures or ethylene is copolymerized with relatively long-chain olefinic monomers to give branched and therefore less crystalline polymer structures. A further process for obtaining polyethylene waxes is thermal degradation of polyethylene polymer under inert conditions. Further details may be found in Ullmann's Encyclopedia of Industrial Chemistry, 5^{th} edition, vol. A 28, Weinheim 1996, chapter 6.1.1. (high-pressure polyethylene waxes), chapter 6.1.3. (polyolefin waxes by Ziegler-Natta polymerization) and chapter 6.1.4. (polyolefin waxes by thermal degradation). The preparation of the invention contains up to 10% by weight, preferably up to 5% by weight, of polyethylene wax.

Possible recent or fossil vegetable waxes, which can be additionally present in native or chemically modified form in the preparation in order to optimize the paste properties, are, for example, carnauba wax, candelilla wax, sugar cane wax or montan wax. Such components can be present either individually or in any mixture in total proportions of up to 10% by weight, preferably up to 5% by weight.

As organic solvents, use is usually made of liquid hydrocarbons such as aromatics-containing or aromatics-free petroleum spirits (e.g. “white spirit”) or turpentine oil.

### EXAMPLES

The acid numbers were determined in accordance with DIN 53402, the hydrolysis numbers were determined in accordance with DIN 53401, the dropping points were determined in accordance with DIN 51801-2, and the flow hardnesses were determined in accordance with the “Einheitsmethoden” M-IV 2 (75) or M-III 13(75) of the Deutschen Gesellschaft für Fettchemie.

### Production of the Pastes:

The wax components were weighed in the amounts indicated in table 2 (in each case in g) into a glass beaker and melted together. The indicated amount of white spirit, which had been preheated to about 40° C., was stirred into the melt having a temperature of about 120° C. The mixture was heated further whilst stirring until the waxes had dissolved to give a clear solution. The solution was brought to a temperature 2° above the solidification point of the melt of the wax mixture (determination of the solidification point in accordance with DIN ISO 2207). A shoe cream tin (diameter 6.2 cm, height 1.3 cm) which had been precooled to 10° C. was filled to the brim with the solution which had been brought to the specified temperature. The filled tin was allowed to cool in a refrigerator at 10° C. for 15 minutes.

### Determination of the Evaporation Loss:

The tin which had been stored for 15 minutes was weighed (initial weight A) and stored open at 23° C. for seven days. The tin was subsequently weighed again (final weight E). The evaporation loss is given by the difference A-E, based on the amount of solvent initially present in the poured-in sample and expressed in percent by weight.

### Determination of the Shine:

Five rectangular areas having dimensions of 5×8 cm were marked out on black linoleum and 16 mg of the paste produced as above was uniformly rubbed by means of a finger onto each rectangle. After a drying time of 20 minutes, the rectangle was polished with a soft brush (200 brush strokes). A shine measurement (measuring instrument BYK gardner micro Trigloss, measurement angle 60°) was subsequently carried out on each area and the average of the five measured values was calculated.

### Determination of the Oil Content:

As a measure of the oil content, the acetone-soluble fraction of each rice wax batch was determined at room temperature. For this purpose, 2 g of milled crude montan wax were completely dissolved by means of 15 ml of hot toluene in a 50 ml volumetric flask and subsequently made up with acetone at room temperature to the 50 ml mark (calibration mark), shaken and stored at 0° C. for two hours. If the solution is then below the 50 ml mark, it is again made up with acetone solvent (0° C.) to the 50 ml mark and the suspension is subsequently filtered. The two fractions are combined, dried and weighed. The oil content correlates with the percentage mass content from the dissolved acetone fraction in this method.

Rice wax type 1 was separated into a hard wax fraction and a wax wax fraction by fractionation using isopropanol. For this purpose, 100 g of rice wax type 1 were dissolved in 700 g of isopropanol under reflux (82° C.) and subsequently cooled to 70° C. The suspension formed is filtered after one hour at 70° C. The solution is concentrated and dried together with the filtered cake at 60° C./50 mbar in a vacuum drying oven for eight hours. This gives a hard wax fraction (58.0 g, rice wax type 5) and a soft wax fraction (40.2 g, rice wax type 6) (see table 1).

TABLE 1
Raw materials used

| | | Acid | Hydrolysis | Dropping | Oil | Flow |
|---|---|---|---|---|---|---|
| | | number | number | point | content | hardness |
| | | [mg KOH/g] | [mg KOH/g] | [° C.] | [%] | [bar] |
| Rice wax type 1 | Refined RBW | 8.1 | 88.2 | 78 | 5.6 | 258 |
| Rice wax type 2 | Refined RBW | 6.3 | 81.4 | 78 | 2.5 | 331 |
| Rice wax type 3 | Naturally refined RBW | 5.1 | 73.0 | 79 | 6.6 | 233 |
| Rice wax type 4 | Naturally refined RBW | 7.8 | 76.0 | 76 | 1.1 | 391 |
| Rice wax type 5 | Fractionated RBW | 3.5 | 84.0 | 79 | 2.4 | 373 |
| | type 1 - hard wax | | | | | |
| Rice wax type 6 | Fractionated RBW | 16.3 | 115.0 | 72 | 8.4 | 183 |
| | type 1 - soft wax | | | | | |
| Licowax ® OM | Chemically refined | 23.0 | 115.0 | 93 | — | — |
| | montan wax, | | | | | |
| | esterified and | | | | | |
| | partially hydrolyzed | | | | | |
| Licowax ® O | Chemically refined | 12.0 | 110.0 | 102 | — | — |
| | montan wax, | | | | | |
| | esterified and | | | | | |
| | partially hydrolyzed | | | | | |
| Licowax ® E | Chemically refined | 18.0 | 145.0 | 82 | — | — |
| | montan wax, esterified | | | | | |
| Carnauba T4 | Carnauba wax | 7.0 | 83.0 | 84 | — | — |
| Licowax ® PE 520 | Polyethylene wax | 0.0 | 0.0 | 123 | — | — |
| Ozokerit 2089 | Microcrystalline | 0 | 0 | 57 | — | — |
| | paraffin | | | | | |
| Block paraffin 5603 | Macrocrystalline | 0 | 0 | 57 | — | — |
| | paraffin | | | | | |

White spirit was used as solvent.
Sources:
Licowax ® grades: Clariant Produkte (Deutschland) GmbH
Carnauba T4, Ozokerit: Ter Hell & Co. GmbH Block paraffin 5603: Sasol Wax.

The examples in table 2 show that in a conventional paste formulation based on partially synthetic montan wax or carnauba wax, the shine values are improved and in particular the evaporation losses are reduced when these waxes are replaced by rice wax.

TABLE 2
Examples

| | 1 | 2 | 3 | 4 | 5 | 6 | 7 | 8 |
|---|---|---|---|---|---|---|---|---|
| Example | (inv.) | (inv.) | (inv.) | (inv.) | (inv.) | (inv.) | (comp.) | (comp.) |
| Rice wax type 1 | 7.9 | | | | | | | |
| Rice wax type 2 | | 7.9 | | | | | | |
| Rice wax type 3 | | | 7.9 | | | | | |
| Rice wax type 4 | | | | 7.9 | | | | |
| Rice wax type 5 | | | | | 7.9 | | | |
| Rice wax type 6 | | | | | | 7.9 | | |
| Carnauba T4 | | | | | | | 7.9 | |
| Licowax ® O | | | | | | | | 4.9 |
| Licowax ® OM | | | | | | | | 3.0 |
| Licowax ® E | 1.0 | 1.0 | 1.0 | 1.0 | 1.0 | 1.0 | 1.0 | 1.0 |
| Licowax ® PE 520 | 2.0 | 2.0 | 2.0 | 2.0 | 2.0 | 2.0 | 2.0 | 2.0 |
| Ozokerit 2089 | 1.2 | 1.2 | 1.2 | 1.2 | 1.2 | 1.2 | 1.2 | 1.2 |
| Block Paraffin 5603 | 14.8 | 14.8 | 14.8 | 14.8 | 14.8 | 14.8 | 14.8 | 14.8 |
| White Spirit | 73.1 | 73.1 | 73.1 | 73.1 | 73.1 | 73.1 | 73.1 | 73.1 |
| Shine [%] | 27.0 | 24.0 | 29.0 | 23.0 | 28.0 | 31.0 | 22.0 | 21.0 |
| Evaporation loss | 11.0 | 5.1 | 7.5 | 5.8 | 16.2 | 31.9 | 18.2 | 32.3 |
| (7 days) [%] | | | | | | | | |

1. A paste-like preparation comprising
0.5-30% by weight of chemically unmodified rice bran wax,
0.5-30% by weight of paraffin wax selected from the group consisting of macrocrystalline and microcrystalline paraffins and Fischer-Tropsch paraffins,
optionally up to 10% by weight of polyethylene wax,
optionally up to 10% by weight of native or chemically modified recent or fossil vegetable waxes and also
organic solvents to make up to 100% by weight.

2. The paste-like preparation as claimed in claim 1, wherein the chemically unmodified rice bran wax has been treated with hydrogen peroxide, with bleaching earth, activated carbon or mixtures thereof.

3. A process for producing paste-like preparations as claimed in claim 1, by mixing the components at elevated temperature and cooling the mixture.

4. A floor care preparation comprising a paste-like preparation as claimed in claim 1.

5. An automobile body comprising a paste-like preparation as claimed in claim 1.

6. A leather preparation comprising a paste-like preparation as claimed in claim 1.

7. A shoe care preparation comprising a paste-like preparation as claimed in claim 1.
